(19) United States
(12) Patent Application Publication
(10) Pub. No.: US 2017/0215379 A1
(43) Pub. Date: Aug. 3, 2017

(54) PET COMB

(71) Applicant: David Hadden, Los Altos, CA (US)

(72) Inventor: David Hadden, Los Altos, CA (US)

(21) Appl. No.: 15/079,665

(22) Filed: Mar. 24, 2016

Related U.S. Application Data
(60) Provisional application No. 62/288,814, filed on Jan. 29, 2016.

(51) Int. Cl. A01K 13/00; B25G 3/00

(52) U.S. Cl. CPC A01K 13/002; B25G 3/00

(57) ABSTRACT

A pet comb is disclosed that includes a handle and a comb blade coupled to the handle, the comb blade having a plurality of resilient tines, wherein at least one of the plurality of tines is blunt-ended.

### CROSS-REFERENCE TO RELATED APPLICATIONS

This application claims the benefit of U.S. Provisional Application 62/288,814 filed on Jan. 29, 2016 which is incorporated herein by reference in its entirety to provide continuity of disclosure.

### TECHNICAL FIELD

This disclosure relates to relates to pet products, and more specifically to pet combs for removing loose hair from animals.

### BACKGROUND

The statements in this section merely provide background information related to the present disclosure and may not constitute prior art.

Examples of references related to the present invention are: U.S. Pat. No. 2,655,482; U.S. Patent Publication No.: 2009/0272332; U.S. Pat. No. 8,042,492; U.S. Pat. No. 3,308,500; U.S. Patent Publication No.: 2004/0065271; U.S. Pat. No. 3,574,885; U.S. Patent Publication No.: 2007/0084416; and U.S. Patent Publication No.: 2005/0150465.

Known pet combs, including those mentioned above, suffer from a number of disadvantages, including but not limited to: being expensive for the end consumer, poor control and customization in regards to how the tines traverse the hair of the animal, causing pain to the animal, taking too long to remove desired hair quantities, not being customizable to different animals and/or hair types, not being able to change performance characteristics during use, requiring tooling costs to manufacture varying kit components, requiring tooling costs to manufacture custom sets/kits for particular brands, and/or the like and/or combinations thereof.

What is needed is a pet comb that solves one or more of the problems described herein and/or one or more problems that may come to the attention of one skilled in the art upon becoming familiar with this specification.

### SUMMARY

A pet comb is disclosed that includes a handle and a comb blade coupled to the handle, the comb blade having a plurality of resilient tines, wherein at least one of the plurality of tines is blunt-ended.

In one embodiment, the blunt-ended tines are at a forward-most position on the comb blade.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1A is a top perspective view of a pet comb, in accordance with the present disclosure;

FIG. 1B is a top perspective view of a pet comb having a further embodiment of a handle insert, in accordance with the present disclosure;

FIG. 2 is a side elevational view of the pet comb, in accordance with the present disclosure;

FIG. 3 is a top plan view of the pet comb, in accordance with the present disclosure;

FIG. 4 is a bottom plan view of the pet comb, in accordance with the present disclosure;

FIG. 5 is a bottom perspective view of the pet comb, in accordance with the present disclosure;

FIG. 6 is an exploded view of the pet comb, in accordance with the present disclosure;

FIG. 7 is a cross-sectional perspective view of the pet comb, in accordance with the present disclosure;

FIG. 8 is a front view of the pet comb with a comb blade removed, in accordance with the present disclosure;

FIG. 9 is a cross-sectional side view, in accordance with the present disclosure;

FIG. 10 is an enlarged cross-sectional view, in accordance with the present disclosure;

FIG. 11A shows an exemplary comb blade, in accordance with the present disclosure;

FIG. 11B shows various view of the exemplary comb blade to illustrate exemplary dimensional relationships, in accordance with the present disclosure;

FIGS. 12A-12C show further embodiments of the comb blade, in accordance with the present disclosure;

FIGS. 13A-13B show further embodiments of the comb blade, in accordance with the present disclosure;

FIGS. 14A-14C show further embodiments of the comb blade, in accordance with the present disclosure;

FIG. 15 shows a further embodiment of the comb blade having an enlarged end width, in accordance with the present disclosure;

FIGS. 16A-16H show further embodiments of the comb blade having a narrow end width, in accordance with the present disclosure;

FIGS. 17A-17C show various embodiments of exemplary ends of tines, in accordance with the present disclosure;

FIGS. 18-25 shows further embodiments of a comb blade, in accordance with the present disclosure;

FIG. 26 shows a series of enlarged views of an exemplary comb blade, in accordance with the present disclosure;

FIGS. 27-31 show another exemplary pet comb, in accordance with the present disclosure;

FIGS. 32A and 32B show exemplary comb blades, in accordance with the present disclosure;

FIG. 33 shows the exemplary pet comb depicting installation of an exemplary comb blade, in accordance with the present disclosure;

FIG. 34 shows an exemplary arm hook used to engage a comb blade, in accordance with the present disclosure;

FIG. 35 shows the pet comb in two exemplary positions, in accordance with the present disclosure; and

FIG. 36 illustrates operation of the comb blades, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Similarly, the phrases “in one embodiment,” “in various embodiments” or “in some embodiments,” as used herein, when used multiple times, does not necessarily refer to the same embodiments, although it may. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.” The term “based upon” is not exclusive and allows for being based on additional factors not described, unless the context clearly dictates otherwise. The word “exemplary” is used herein to mean “serving as an example, instance, or illustration.” Any aspect described herein as “exemplary” is not necessarily to be construed as exclusive, preferred or advantageous over other aspects.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

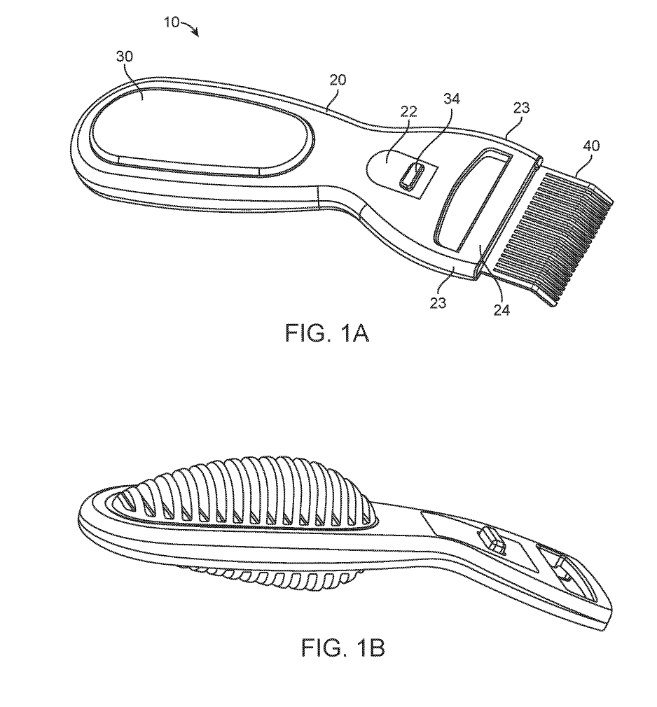

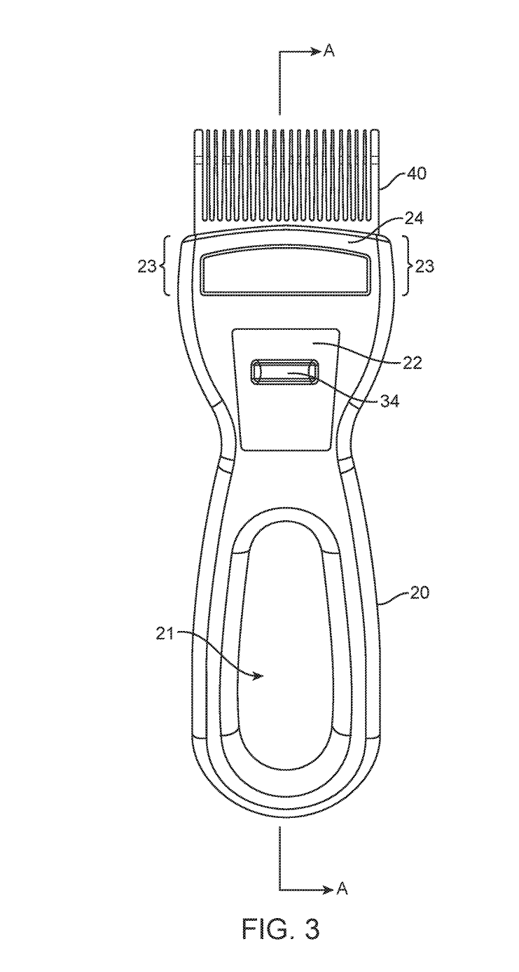

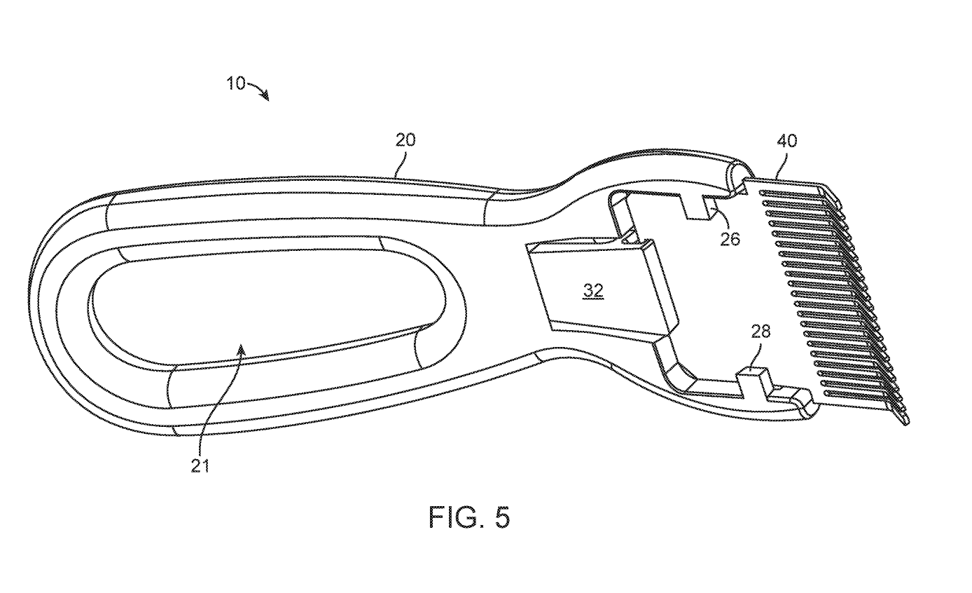

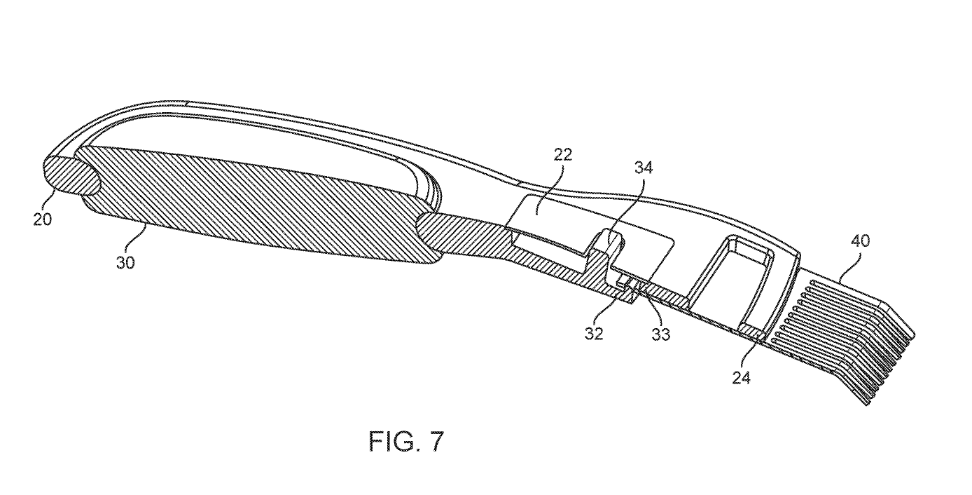

Referring now to the drawings, wherein the depictions are for the purpose of illustrating certain exemplary embodiments only and not for the purpose of limiting the same, FIGS. 1A-7 show one embodiment of a pet comb 10. As FIG. 1A shows, the pet comb 10 includes a handle 20, a cosmetic cover plate 22, a handle insert 30, and a comb blade 40. The comb blade 40 may be selectively coupled to the handle 20 as described herein below. The pet comb 10 is configured to allow a user to remove loose hair/fur from an animal, which helps keep an animal's coat healthy, reduces mess associated with gradual shedding, and also helps create a bond between pets and their owners.

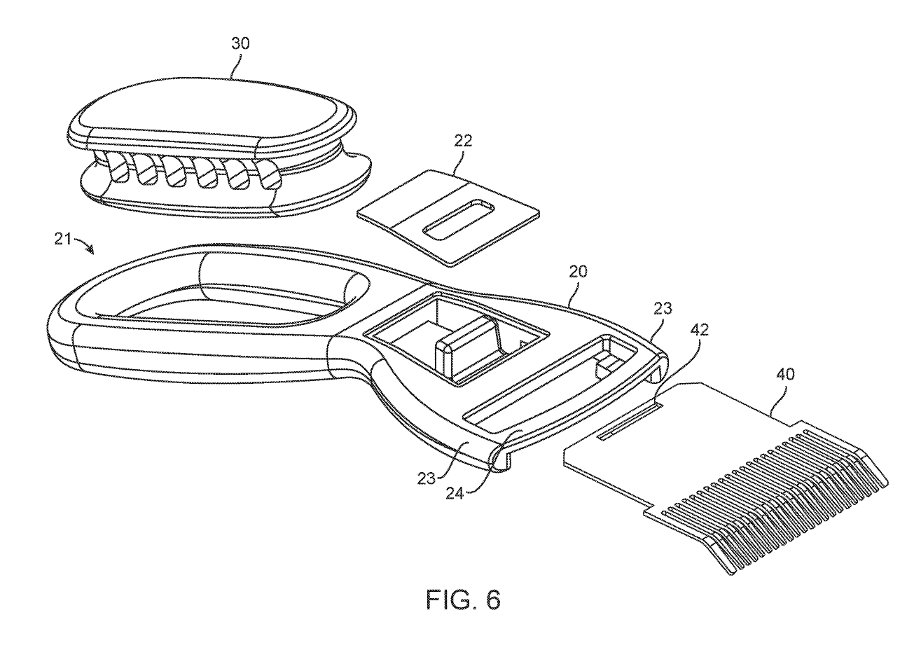

The handle 20 of the pet comb 10 is configured to be used to manipulate and maneuver the pet comb 10 about a pet or animal. The illustrated handle 20 may be formed of a single elongated support structure having a handle insert 30 disposed therethrough and a comb 40 inserted within support structure at a distal end. In one embodiment, the handle 20 formed of a single elongated support structure is advantageously shaped to be able to be easily manufactured without difficult or expensive injection molding techniques, e.g. slides, lifts, split cavities, overmolding. The single elongated support structure includes an aperture 21 through which the handle insert 30 may be disposed as shown in FIG. 6. Wherein the handle insert 30 is shaped to friction fit or otherwise grip an interior region of the aperture 21, the handle insert 30 may be fixed in place without the use of other attachment devices/structures. In one embodiment, the handle insert 30 may be fixed to interior surfaces of the handle 20 that forms the aperture 21 by glues/adhesives.

The handle insert 30 may be formed of an elastically flexible material e.g., plastics, foam, or rubber. In various embodiments, a durometer of a rubber handle insert embodiment can be varied over a wide range. The handle insert 30 can also be made of foamed rubber to reduce weight and cost. It is preferable that the handle insert 30 is formed of a single integral piece, i.e., a one-piece mold, but may be integral to the handle 20 or formed of a plurality of portions. It is contemplated that the handle insert 30 may be various shapes and sizes including the shape and size shown in exemplary FIG. 1A, but may also be shaped and sized as shown in exemplary FIG. 1B or as desired for comfort or ergonomic purposes.

The handle insert 30 may deformed during insertion into the handle insert 30 aperture 21 and then may spring into a more locked position thereinside, mating an interior surface of the aperture 21 with the handle insert 30. Accordingly, during the manufacturing process, a great variety of handle 20 bodies and/or inserts 30 may be produced but not assembled until specific orders of specific combinations of the same are received, thus allowing for a greatly multiplied offering of styles, while maintaining a reasonable level of inventory requirements. As combs 10 are also creatable in a great variety of characteristics and able to be combined during assembly and packaging, the variety is again multiplied without a proportional inventory storage increase.

The handle 20 is preferably formed of a single elongated support structure, which may be plastic or other polymer-based material, metal or ceramic. The handle 20 may be ergonomically shaped and beneficial for purposes of stopping repetitive stress issues for users. In various embodiments, the handle 20 may have post-molding treatments, e.g. coloring, decorative layers, ergonomic layers, gripping enhancement treatments.

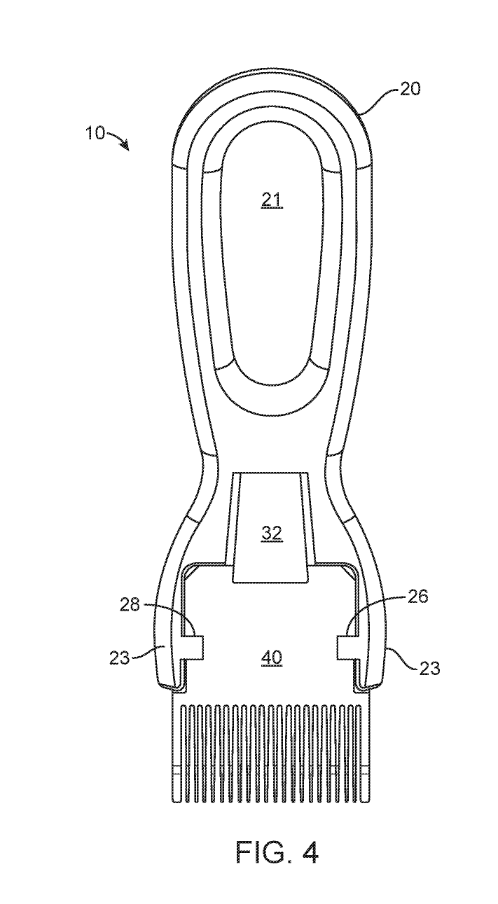

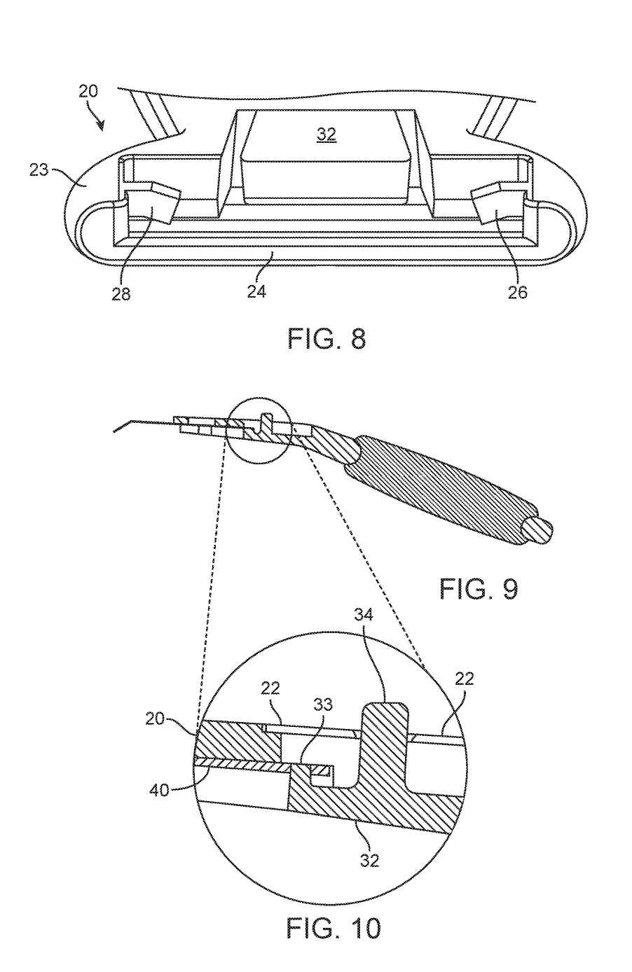

The handle 20 includes bracing structure for coupling and holding the comb blade 40. In one embodiment, a top brace bar 24 is formed of the handle 20 that cooperate with a first and second bottom brace members 26 and 28, respectively, to provide a slidably insertable space into which the comb 40 may be inserted. The top brace bar 24 and the first and second bottom brace members 26 and 28, in cooperation, restrict motion of the comb 40 within the insertable space. In one embodiment the first and second bottom brace members 26 and 28 may be formed of a single bar spanning a width of the handle 20 or may be formed as tabs such as shown in FIGS. 4, 5, and 8. However, in a variety of different embodiments, the blade 40 could be attachable to the handle 20 in a variety of ways, for example, a friction fit, a slot, a snap fitting that locks the blade into place, a fastener to attach the blade to the handle, a catch lever, or any other method of attachment known in the art including insert molding the comb blade 40 into the second portion 39.

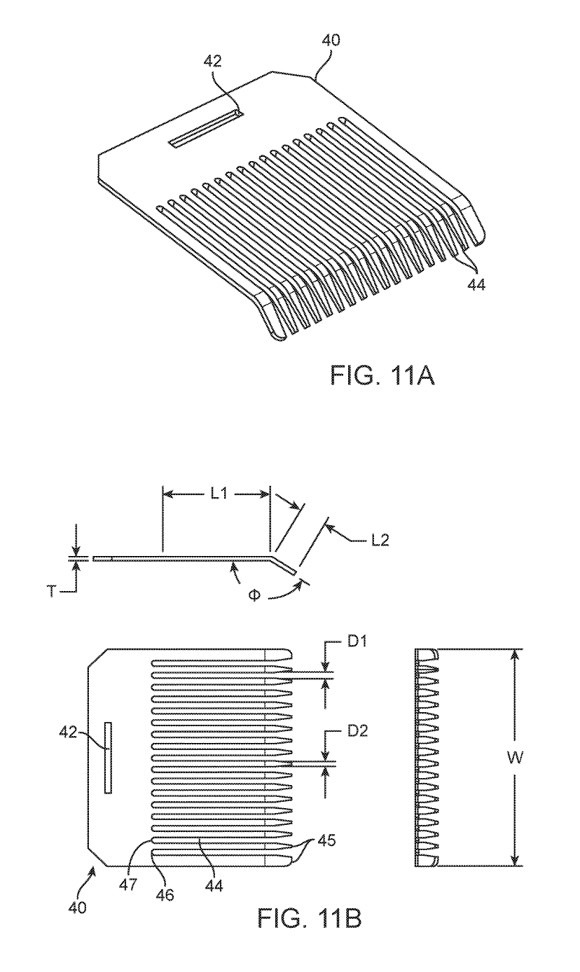

In various embodiments, the handle 20 includes a first portion 29 adapted for gripping by the user and a second portion 39 having structure and coupling for the comb blade 40. The first portion 29 and the second portion 39 may be joined at an angle ‘σ’ which is preferably obtuse but may be flat at 180-degrees in some embodiments. To put in another way, the first portion 29 may be bent at an angle ‘z’ relative to the second portion 39. The first portion 29 includes a longitudinal axis 31 extending from a distal end to the second portion 39. The second portion 39 includes a longitudinal axis 35 extending from the first portion 29 to the comb blade 40. A longitudinal axis 37 of the bent portions 49 of the tines 44 extends from an end 45 of the tines 44 to a vertex of the L1 and L2 portions of the tines 44. As described herein below with reference to FIG. 11B, the angle ‘φ’ may be obtuse, but may range from essentially 180-degrees to almost 0-degrees. In various embodiments, the angle ‘β’ defined by the intersection of axis 31 and 37 may range from 180-degrees to 0-degrees, but may be obtuse. A angle ‘y’ of which the tines 44 are bent, is dependent, in part, upon the angle ‘z’ that the handle 20 is angled. In one embodiment, the combined angles of ‘y’ and ‘z’ are between 0-degrees and 180-degrees. In one embodiment, the combined angles of ‘y’ and ‘z’ are between 45-degrees and substantially 90-degrees. However, these angles may be variously designed to provide desirable characteristics, and be within the scope of this invention.

In one embodiment, a catch member 32 is a tab extending from an underside of the body of the handle 20 with a tab or latch 33 protruding upwardly therefrom. In various embodiments, the catch member 32 may be sized and positioned to be flexible and/or resilient, but may operate as a support for the comb blade 40 when the comb blade 40 is butted up against a rear of the latch 33 while also operating as a leaf spring for the catch 32 when the comb blade 40 engages with the latch 33. In one embodiment, the catch 32 includes a protrusion 34 preferably integral to the catch member 32. The protrusion 34 functions as a release button when the catch 32 is flexible, enabling a user to depress the catch 32 by pressing down on the protrusion 34, thereby retracting the latch 33 from a coupling aperture, slot, or opening of the comb blade 40. In one embodiment, the latch 33 is at the forward-most region of the catch member 32. The catch member 32 does not overlap with any of the other brace member structures and thus may be formed through simple injection molding processes and thereby be constructed very easily and with minimal costs when compared to other securing structures for holding similar inserts. In another embodiment, the blade 40 may be attached to handle 20 using different attachment methods, as discussed above.

The catch member 32 may restrict the lateral motion of the comb when engaged with a coupling aperture 42 of the comb. In one embodiment, the catch member 32 is shaped to gradually withdraw as the comb 40 is inserted and then to spring into the coupling aperture 42. In one embodiment, the catch member 32 includes a tab or latch 33 having an inclined plane-shaped end, i.e., wedge shape, inclining facing the direction of the approaching comb 40 so as to gradually withdraw as the comb 40 is inserted and then to spring into the aperture 42 upon appropriate positioning. In one embodiment, the handle 20 does not require any special manufacturing in order to interconnect with the comb blades 40, e.g. slides, draws, etc.

The first top brace bar 24 is essentially a flat bar extending across the width of the handle 20 between arms 23 thereof at the end most opposite from the insert receiving aperture 21 of the handle 20. This top brace bar 24 provides support for the comb 40 during use and resists angular motion of the comb 40 while in operation in cooperation with the first and second bottom brace members 26 and 28 and catch member 32.

In one embodiment, the first and second bottom brace members 26 and 28 extend outwardly from the arms 23 of the handle 20 and at a position to allow for a vertical spacing between the first and second bottom brace members 26 and 28 and the top brace bar 24 about the thickness of the blade of the comb 40. In most operational uses, the first and second bottom brace members 26 and 28 are not expected to experience forces to the same degree as the top brace bar 24 and therefore may be smaller and less extensive. This also allows for easier insertion of the comb 40 as the first and second bottom brace members 26 and 28 may flex slightly during insertion as necessary.

In another embodiment, a second top brace bar 25 may be utilized. In various embodiments, the second top brace bar 25 is essentially a flat bar extending across the width of the handle 20 between arms thereof and spaced behind the first top brace bar 24 and bottom brace bar 27 but in front of the catch member 32. The second top brace bar 25 cooperates with the bottom brace bar 27 to hold the comb 40 in place and to prevent the comb blade from disengaging from the catch 32. The brace bars are all spaced apart from each other and non-overlapping from a top or bottom view. This non-overlapping structure allows for construction using simple injection molding techniques which are less expensive.

The comb blade 40 may be inserted amongst and between the catch member 32, the top brace bar 24, the arms 23, and the first and second bottom brace members 26 and 28 of the handle 20. However, there are a variety of different blade attachment designs and method that may be designed within the spirit of the disclosed invention.

Turning to FIG. 11A, this embodiment shows an exemplary comb blade 40. The comb blade 40 includes an aperture 42 in the rear portion thereof that is shaped, sized and positioned to mate with the latch 33 of the catch member 32 of the handle 20 when the comb blade 40 is fully inserted therein. Thus the comb blade 40 may be selectably coupled thereto in an easy manner. The catch member 32 and latch 33 may be depressed, such as but not limited to by operation of a user's thumb, and once so disengaged from the comb blade aperture 42 allows for the comb blade 40 to be withdrawn forwardly out of the handle 20 through the vertical spacing between the top brace bar 24 and the first and second bottom brace members 26 and 28.

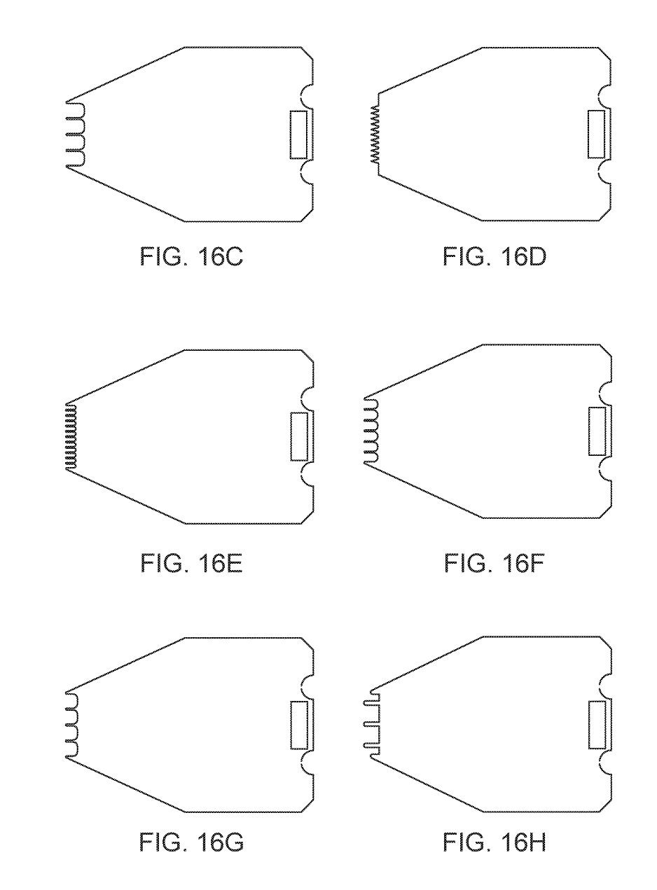

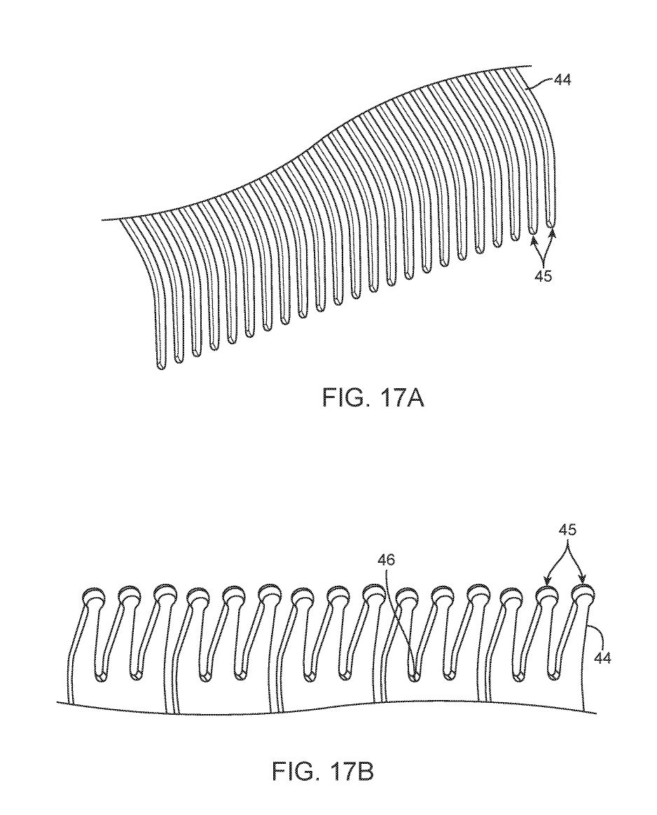

In various embodiments, the comb blade 40 includes a spaced array of tines that may be flexible or stiff. In one embodiment, flat tines 44 extend outwardly away from the handle 20 when connected. In many embodiments, ends 45 of the tines 44 are processed to not include sharp edges or blades. These may include tips or ends that are widened, flattened, balled, twisted, vibra-honed, electroplating, dipping, coating, etc. such as shown in FIGS. 16A-16C. In one embodiment, a structure of the comb blade 40 is designed so that the comb blade 40 does not nick, tear or damage the hair, fur, or skin of the animal while still removing loose, dead hair, and/or fur.

The comb blades 40 can be made out of many different materials including metals, plastics such as Grivory GV or Grivory GVX, and composites. In one embodiment, the comb blade 40 is a single piece of formed metal. In one embodiment, a 17-7 stainless condition C material In another embodiment 1050 stamped steel that has been austempered is used. Other steels such as AISI SAE 1045, 1050, 1055, 1060, 1070, 1074, 1075, 1080, 1085, 1090, 1095 and the like can also be used. Further, comb blades 40 may be made by either chemical etching, which is helpful for short runs and small quantities, or stamping, which generally produces lower cost parts, but more expensive tooling. Chemical etching parts can be milled to more intricate shapes that can't be easily made by stamping. However, the blade may be made by a variety of other processes, such a laser cutting, stamping, or fineblanking. Further, the blade may be made of any material with suitable material properties.

FIG. 11B show an exemplary comb blade 40 in various views to illustrate exemplary dimensional relationships. As FIG. 11B shows, the comb blade 40 can include an array of tines 44, i.e., teeth, extending forwardly therefrom. The tines 44 have an originating end 47 and an end 45 that defines the length of the tines, e.g., the sum of ‘L1’ and ‘L2’. The tines 44 are spaced to form rounded concave spacings 46 between tines.

The tines 44 have a pre-bend length ‘L1’ and a thickness ‘T.’ The teeth 44 can be spaced apart at an equal distance ‘D1’ and each have a similar width ‘D2’. In one embodiment, the tines 44 are bent, curved, or otherwise formed at an angle ‘φ’ at a pre-bend length distance from a forward end of the handle 20 and then continue for a post-bend length ‘L2’ to the tips of the tines thereof such as shown in the exemplary embodiment of FIGS. 11A and 11B. In addition, these angles may alternate. For example, the blunt tines may be at a different angle than the sharp tines.

In various embodiments, the tines 44 may be spaced apart from each create the slot describe above, to allow for the collection of hair/fur therebetween, but are not so far apart that they will not trap and catch such hair as desired. The bend in the tines 44 allows for increased force to be applied at the tips of the tines during use and also strengthens the tines 44 against sideways forces that may mangle or misalign the tines 44. The long tines 44 allow for spacing in which to trap substantial quantities of hair during use and thus extend the operational life of the comb blade 40 before it must be cleaned as compared to shorter deshedding tools.

The amount of flex may be controlled based upon a length ‘L1’ in conjunction, thickness ‘T’, blade spacing ‘D1’, blade width ‘D2’ and the material from which the blade 40 is fabricated. Flex in the comb blade 40 is important as it reduces the chances of scratching an animal's skin where the skin has bumps or other irregularities on it during use. Different blade embodiments may have different angles ‘φ’ which may be selected depending on the type or condition of the fur or hair. In some embodiments, the angle ‘φ’ can vary from 90-degrees to substantially 179-degrees. In some embodiments, the angle ‘φ’ may vary from between about 0, 10, 20, 30, 40, 50, 60, 70, 80, 90, 100, 110, 120, and 130-degrees. There may also be a range of about 45 to about 65 degrees in tine bend. Likewise, the angle ‘β’ of the handle 20 and the mounting angle of the comb blade 40 may also vary from between about 0, 10, 20, 30, 40, 50, 60, 70, 80, 90, 100, 110, 120, and 130 degrees. In addition, it may be desirable to have a single blade 40 with different, or alternating, tine lengths, tine angles, tine spacings (slot widths), or tine ends (blunt or sharp).

The length ‘L2’ may be set based upon a thickness of the animal's coat being groomed and the type of hair. Animals with wavy coats and thick hair generally require a shorter length ‘L2’ for initial grooming. After initial grooming with a shorter length ‘L2’, all other comb design parameters being the same, a comb blade designs with progressively longer lengths ‘L2’ can successfully be used.

Fine thin hair and short hair generally require teeth with closer spacing ‘D1’ than does dense hair and long coarse hair. A right or acute angle ‘φ’, a short length ‘L2’ and a narrow width ‘W’ dimension can be used for detangling. The advantage is that only a small amount of tangled hair or fur is pulled during the detangling process thus creating less pulling on the animal's fur or hair during the detangling process. Comb blades 40 can be adapted for specific types of hair.

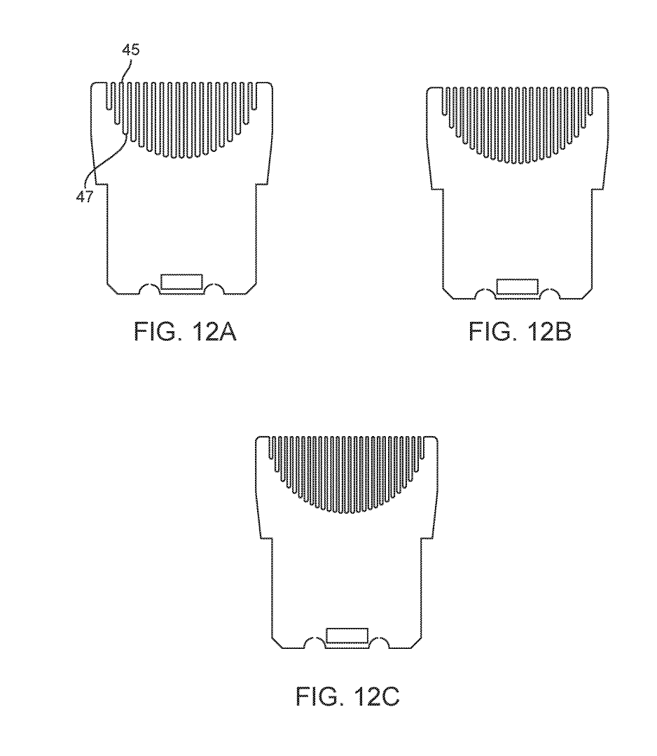

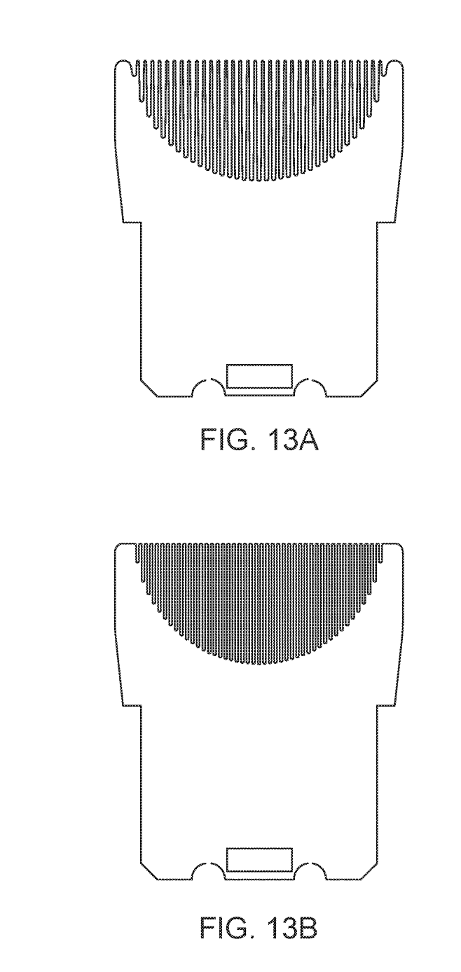

Turning to FIGS. 12A-12C and FIGS. 13A-13B, these figures show various embodiments of the comb blade 40. As FIGS. 12A-12C and FIGS. 13A-13B show, various embodiments can incorporate variations on width, spacing, and shape of the tines. In various embodiments, the tines 44 may be tapered. A length of the taper can be adjusted as needed to obtain desired flex vs. displacement profiles. As shown, tine length may be varied by incorporating a semicircular arrangement of the tines within the comb blade 40, in which the inner tines have a greater length than the outer tines. While a semicircular shape is depicted, most any profile desired may be utilized in various embodiments. In some cases, where extra flex in the middle is required, an elliptical shape may be desired. In certain embodiments, space between tines do not need to be consistent across the width ‘W’. It may be desirable to have greater spacing between tines in the middle of the comb width. Similarly, the width of the tines themselves may be varied from tine-to-tine or in some sequential pattern. In one embodiment, a tine array has an arc-shaped length profile so that internal tines are longer and thus more flexible with outer tines being more stiff and shorter.

In one embodiment, the tines 44 are generally wider than the width between each tine. The tines are elongated and trap the hair/fur between the tines 44. The tines 44 may be made of any number of metals and the flexibility and use characteristics may be controlled by the length and thickness of the tines and this allows for a great range of tine configurations with desired operational characteristics for custom comb sets, i.e., the tines may vary in length, thickness, sharpness, and angle, wherein each may be individually tailored.

Turning to FIGS. 12A-12C, these figures show embodiments of the pet comb blade, in which the length of the tines are variable. For example, the tines towards the edges of the blade may be shorter, while the tines towards the center are longer, or vice versa. In such a design, the tines may form a semicircular edge. However, if the leading edge of the blade, which engages the pet, are formed with a straight edge, then the trailing edge of the tines would form a semicircular edge at the base of the tines, as shown in FIGS. 12A-12C. This may provide different stiffnesses of the tines, and may provide advantageous performance. Variable length tines could be provided in a number of different designs and still be within the scope of this disclosure. In addition, it may be desirable to have tines that are also bent at different, or alternating, angles with respect to the plane of the blade.

In various embodiments one or more of the tines may have a flexibility different from nearby and/or adjacent tines. In various embodiments one or more tines is generally inflexible. In various embodiments the tines 44 may be bent downwardly near a far end of the tines and such bending may be at angles other than that illustrated and such angles may vary between different tine pieces and/or vary even among the tines of a single comb blade. Tines may be curled. Tines may be of varying lengths. It may be that one or more tines of a single tine piece do not match other tines of the same tine piece in one or more characteristics.

In another embodiment, the length of the tines or prongs may change over the width of the comber portion. In another embodiment, the width of the tines or prongs may vary over the width of the comber portion. In yet another embodiment, the width of the tines or prongs and the length of the tines and prongs may be individually set. Therefore, the tine width, spacing, angle, and tip may all be tuned, or alternated, for a specific type of coat, or a specific type of treatment desired for the coat.

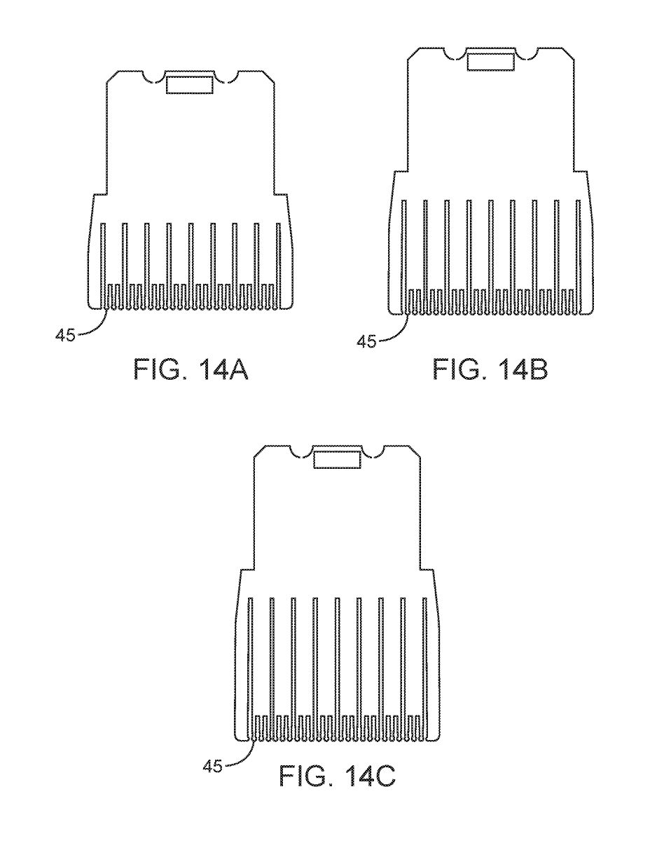

FIGS. 14A-14C show further embodiments of the comb blade 40. As FIGS. 14A-14C show, tine length may be varied across the comb width and varied among different adaptations of the comb blades. For example, FIG. 14A shows shorter tines 44 than those incorporated into the exemplary embodiment shown in FIG. 14C. As further shown in FIGS. 14A-14C, the comb blades 40 may include patterns of varying length tines. In one embodiment, the tines all have balls 45 on ends thereof. One skilled in the art will readily recognize that any number of teeth, spacing and grouping can be used.

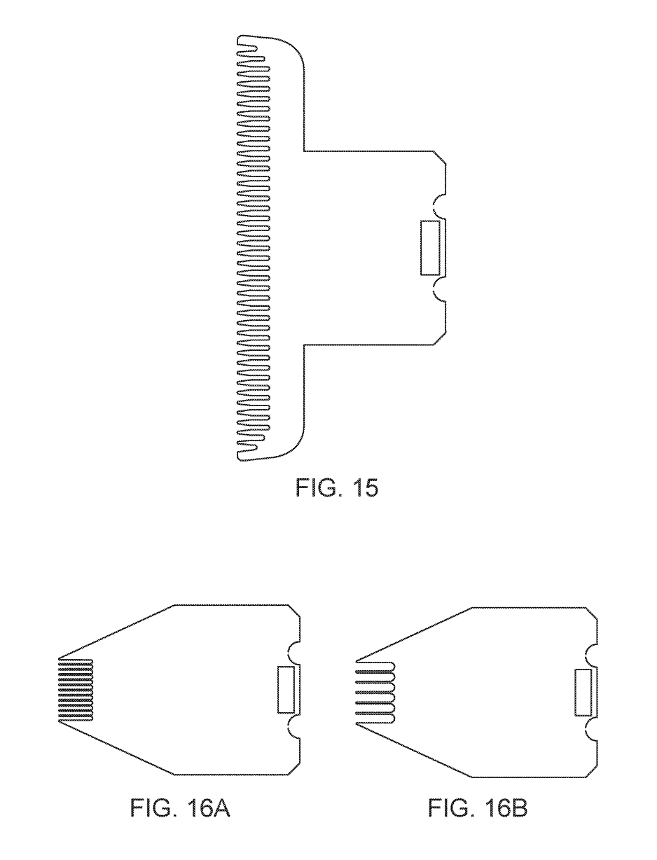

FIG. 15 shows a further embodiment of the comb blade 40 having a width larger than an insert portion. As FIG. 15 shows, in some comb blade embodiments, the width may extend on both sides of the comb blade 40. In various embodiments, the tine arrangements shown in FIGS. 12A-12C, FIGS. 13A-13B, and FIGS. 14A-14C may be applied to embodiments of the comb blade 40 having an enlarged width such as shown in FIG. 15.

FIGS. 16A-16H show further embodiments of the comb blade 40 having a narrow width. Narrow width comb blades are particularly advantaged when applied to removing tangles. For removing tangles fewer teeth with wider spacing between them and a short tine length may be desirable so that a limited amount of hair is detangled at a time thereby reducing a pulling force required to detangle, reducing stress on the animal.

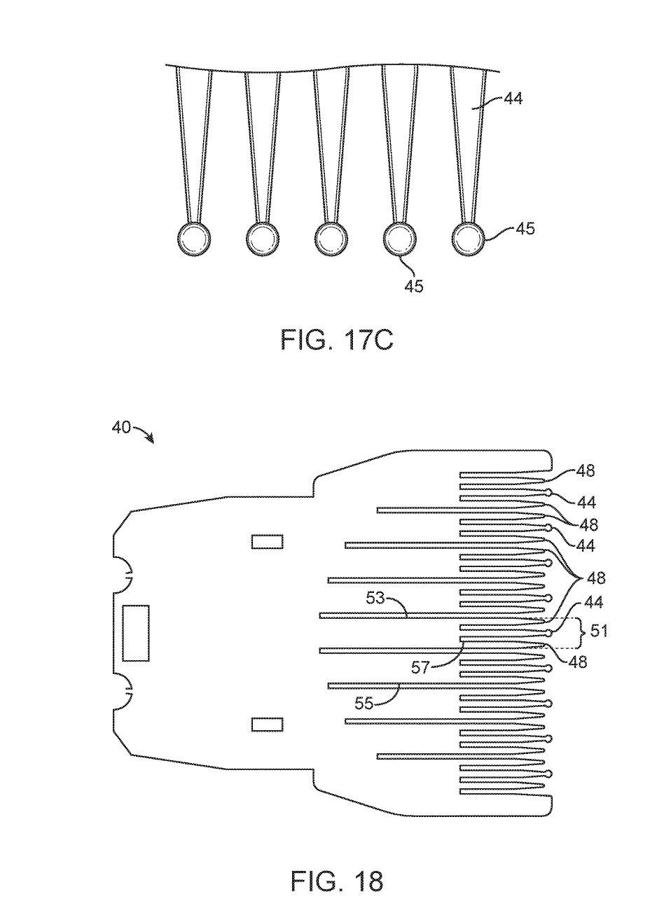

FIGS. 17A-17C show various embodiments of exemplary ends 45 of tines 44. As FIG. 17A shows, the tines 44 may be elongated, slender members with rounded or dulled ends 45. In one embodiment, the ends 45 may be slightly tapered. FIG. 17B shows a rounded end 45 of tines 44 having slightly tapered sides. Rounded concave spacings 46 may be formed between tines 44. The concave spacings 46 may be smooth. The rounded ends 45 are configured to help keep hair trapped between the tines 44 until it is removed by the user and provides a larger smooth surface from which to spread a contact force of the tines 44 when they come in contact with an animal's skin. FIG. 17C shows exemplary rounded ends 45 of the tines 44 formed using a laser pulse. Many metals have high surface tension when they are in a liquid state. Using an appropriate pulse length and magnitude of power applied to the pulse, the tip of a metal tine 44 can be liquefied long enough to form a ball, but of a duration short enough that the ball freezes before it has a chance to drip or run.

In some embodiment, the tines may all be uniform. However, in one embodiment, such as shown in exemplary FIG. 18, it may be advantageous for the tines to have alternating designs. For example, this embodiment may alternate between blunt tines and sharp tines. The blunt tines may be blunted with a variety of designs, such as a rounded end, or other design. The sharp tines may be designed to come to a point, or may be sharp because they have a squared off end. Between these two types of tines may be a space or slot. The base of the slot between the tines may be a flat surface, forming essentially a ninety degree angle with the plane of the blade. However, in yet another embodiment this base of the slot between each tine may be formed at an angle, creating a blade. That is, the design of the invention disclosed herein could be combined with features of a more conventional deshedding blade design.

FIGS. 18-25 shows further embodiments of a comb blade 40. As FIGS. 18-25 show, embodiments of the comb blade 40 may include one or more tines 44 having rounded ends, i.e., blunt ends, and one or more tines 48 that have a pointed end 48, i.e., a non-blunt end. The blunt ends are configured as a guard to engage a surface of the animal's skin and therefore can be shaped in any of: a ball, a sphere, round-shaped, a disk, a dulled-surface, and any other smooth surface. In one embodiment, the blunt ends are formed without edges. In one embodiment, the blunt-ended tines may be formed by softening corners of tines, creating a radius or chamfer. The non-blunt-ended tines 48 may include pointed ends, spear-like ends, wedges, terminating tapers, blades, or other sharp angled structure configured as a de-shedding tine. In one embodiment, the non-blunt-ended tines 48 include edges. In one embodiment, the rounded end tines 44 extend outwardly more than the pointed end tines 48 so as to be in a forward-most position of the comb blade 40.

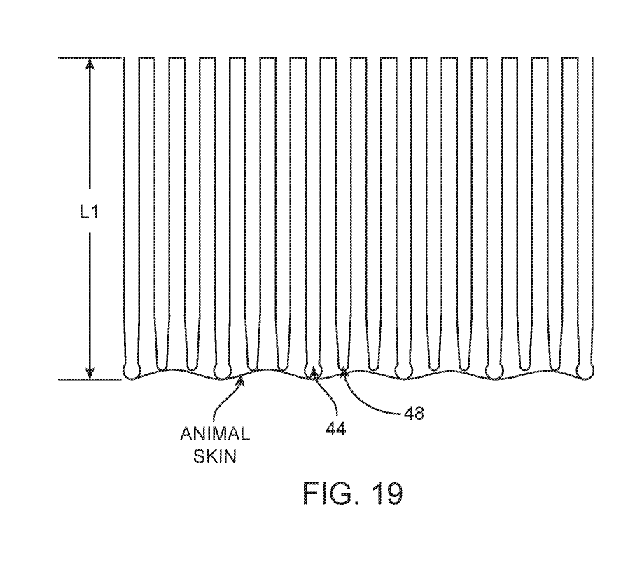

FIG. 19 shows an exemplary plurality of tines for an exemplary comb blade. As FIG. 19 shows, in various embodiments a desirable length ‘L’ is between 0.2 and 1.5-inches although longer and shorter lengths may be used. In one embodiment, the length ‘L’ varies among the blunt-end and the non-blunt-ended tines. For example, as described herein, the blunt-ended tines have a greater length ‘L’ than non-blunt-ended tines. As FIG. 19 shows, the longer blunt-ended tines 44 press into an animal skin being groomed, moving the animal skin away from ends of the shorter non-blunt-ended tines 48.

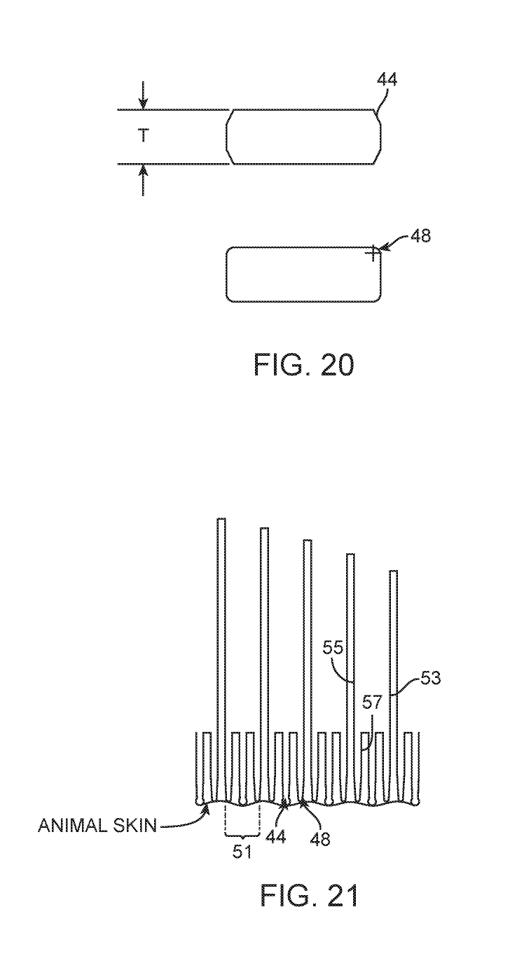

FIG. 20 shows an enlarged view of exemplary blunt-ended tines 44 and non-blunt-ended tines 48 in a cross-sectional at a tip of the respective tines. In one embodiment, a desirable range of thickness for the blunt-ended and non-blunt ended tines 44 and 48 is between 0.012 and 0.024-inches however thicknesses between 0.009 and 0.050-inches may also be used. In various embodiments, a desired radius may depend upon a thickness ‘T’ of the tine. In an embodiment where the thickness T is 0.012-inches, a desirable radius would be between 0.001 and 0.003 inches, for example. For a tine of a comb blade that has a thickness ‘T’ of 0.020-inches, a desirable radius would be between 0.002 and 0.006-inches. Other radii may be desirable. In various embodiments, chamfers may be an artifact of the manufacturing technique and will influence the shape of a radius.

FIG. 21 shows exemplary tine groupings 51. A tine grouping 51, i.e., a tine stalk, is a plurality of tines having a common resilient portion that extends into a comb blade 40. The tine stalks 51 includes a plurality of tines which may a combination of blunt-ended and non-blunt ended tines, although embodiments having only blunt-ended or non-blunt-ended tines are contemplated by the disclosure herein. The stalks 51 share a partially segmented resilient portion, i.e., a stalk, that is defined by sides 53 and 55 and extending a variable length into the comb blade. In one embodiment, the stalk extends into the comb blade 40 a greater length for tines on a side of the tine stalks 51 than inner tines, e.g., side 57. The stalk may include any number of tines, e.g., 2 to 8 tines, and any arrangement or quantity of tine-types. For example, a stalk may include one blunt-ended tines and two sharp-ended tines.

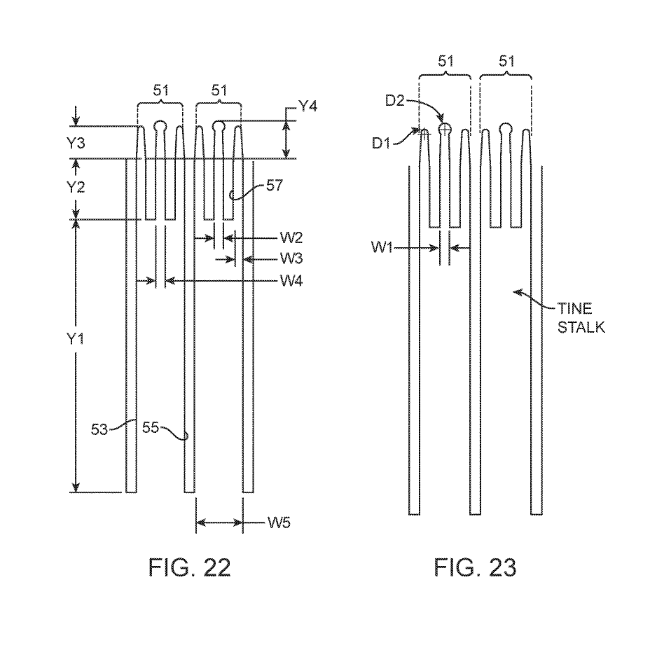

FIG. 22 shows two further exemplary tine stalks 51. As FIG. 22 shows, in one embodiment, a width of tines, e.g., ‘W2’, ‘W3’ and ‘W4’ and the spacing between them are preferably reasonably close together with a desirable blunt-ended tine width ‘W4’ being between 0.02 and 0.05-inches. However, widths in the range between 0.01 and 0.07-inches are also desirable. This same range of dimensions is also desirable for non-blunt-ended tine widths, although in various embodiments it may be advantageous to use different widths for blunt-ended and non-blunt-ended tines within the same comb blade.

The stalks 51 share a partially segmented resilient portion defined by sides 53 and 55 and extending a length ‘Y1’ into the comb blade. In one embodiment, a tine stalk 51 has a length ‘Y1’ that ranges between 0.2 and 2-inches. A comb blade may have a series of different lengths depending on a flex or resiliency profile desired across a width of the comb blade. Similarly, dimensions ‘Y2’, ‘Y3’, and ‘Y4’ may also be predetermined based upon a desired resiliency profile. In one embodiment, a desirable length range for ‘Y2’ is between 0.2 and 1.5-inches. In one embodiment, a desirable range for ‘Y3’ may is also between 0.2 and 1.5 inches. In one embodiment, a desirable range for ‘Y4’ is also between 0.2 and 1.5 inches however, ‘Y4’ may be a different length for a blunt-ended tine than it is for a non-blunt-ended tine. ‘Y2’ may also be different for blunt-ended tines and non-blunt-ended tines. In various embodiments, spacings ‘W2’, ‘W3’, ‘W4’ and ‘W5’ may all vary depending on a particular intended application of the comb blade. For example, the spacings may be adapted to a particular type of hair or fur intended to be groomed.

With reference to FIG. 23, exemplary tine stalks 51 are shown having blunt-ended tines 44 and non-blunt-ended tines 48. In one embodiment for non-blunt-ended tines, a radius ‘D1’ is most desirable between 0.00 and the width of the tine. In one embodiment, a radius of the blunt-ended tine is most desirable between the width ‘W1’ of the tine at a base, e.g., ‘W2’ of FIG. 22, and 2.5 times W1. Other widths can also be used consistent with the teachings herein. The tine stalks 51 in a one embodiment has three tines however; any number between 2 and 8 tines may also be desirable.

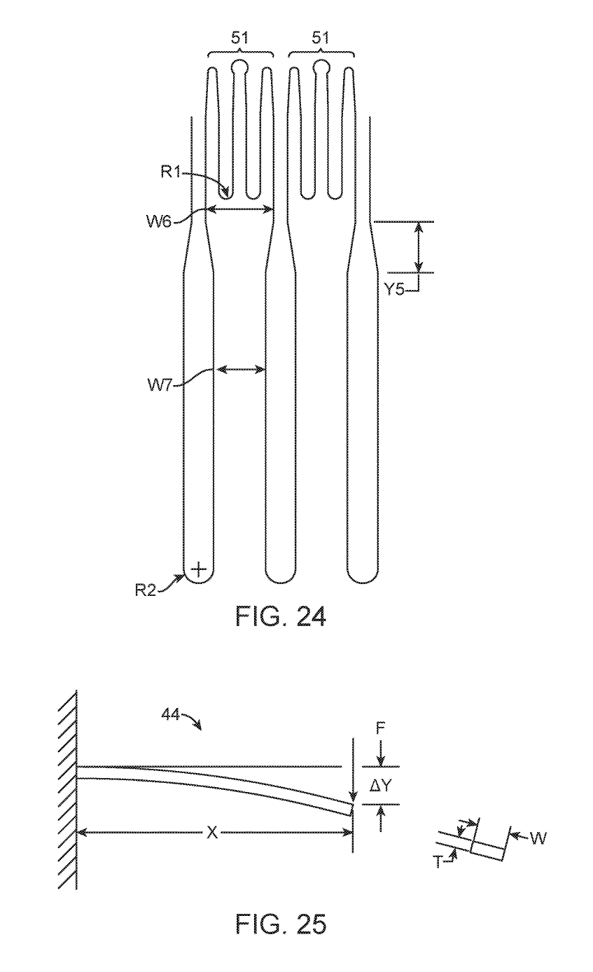

FIG. 24 shows an exemplary partial view of a comb blade having a plurality of tine stalks 51 formed of the comb blade. As FIG. 24 shows, tine stalks 51 can vary in width from ‘W7’ to ‘W6’ over distance ‘Y5’. Variable width of a tine stalk 51 is useful to simplify fabrication when the comb blade 40 is to be stamped. The distance ‘Y5’ can be up to the length ‘Y1’. Radii R1 and R2 are also provided to facilitate the stamping method of fabrication.

In one embodiment, the comb blade 40 is arranged with alternating a single of the blunt-end tines 44 and a plurality of the non-blunt-ended tines 48 such as shown in exemplary FIG. 18. In one embodiment, the comb blade 40 is arranged with alternating the blunt-ended tines 44 and non-blunt-ended tines 48. In one embodiment, the comb blade 40 includes groupings of non-blunt-ended tines 48 having at least one blunt-ended tine 44, wherein the groupings can include tines that share the resilient portion.

FIG. 25 is a side view of an exemplary tine 44 illustrating exemplary resiliency of a tine 44 of a comb blade. FIG. 25 shows a force ‘F’ being applied to the end of an individual tine a distance ‘X’ from a base of the tine 44 or stalk and the end of said tine, said tine having a width ‘W’, and thickness ‘T’. Displacement ‘ΔY’ shows an amount of flex that occurs when a force ‘F’ is applied. Having flexible tines makes it possible to groom more efficiently by allowing the tines to conform to the body structure of the animal being groomed. Having conforming tines is particularly beneficial when grooming along a bony structure such as a leg or down the spinal area of an animal.

A desired amount of force for a given amount of flex is determined by the type of animal being groomed, the type of hair or fur and the age of the animal. Older animals in general have more delicate skin and require a greater flex for a given force.

The flex distance, ΔY or resistance to bending, for a given force is determined by the moment of inertia of a tine. The moment of inertia for a tine with a rectangular cross-section is proportional to the cube of the thickness ‘T’ of a tine multiplied by a width of the tine. Thus, the thickness is exponentially more important to resiliency than a width of the tine.

In addition to physical dimensions, properties associated with material of the comb blade will affect resiliency of the tines and may be selected for a desired flex distance, ‘ΔY’, for a given force ‘F’. Further, the amount of force that can be applied to a tine before plastic, or permanent deformation takes place is determined by the properties of the metal or material formed thereof.

In various embodiments, metals such as 17-7 Condition C stainless steel, medium carbon steel which has approximately 0.29% to 0.54% carbon content with 0.60 to 1.65% manganese content (e.g. AISI 1040 steel) and high carbon steel: approximately 0.55% to 0.95% carbon content with 0.30 to 0.90% manganese content are examples of metals with desirable characteristics for fabricating the comb blades. In various embodiments, the carbon steel materials can be heat treated in various ways to achieve a wide range of specific physical characteristics such as flexural modulus, yield strength, and hardness.

Since the flex distance ‘ΔY’, for a given force ‘F’ is determined by many factors, one way to quantify a range of desired results is to define the physical properties a metal must have to obtain those desired results. Consider a sample of 17-7 Condition C stainless steel. Referring to FIG. 25, and considering a length ‘X’ of about 1-inch, with a width ‘W’ of about 0.135 inches and a thickness ‘T’ of about 0.026-inches a force of about two pounds causes an elastic deformation of about 0.4 inches which is a specific desired result for one embodiment. In this case, a deflection of about 0.6 inches occurred before a plastic deformation of about 0.02-inches occurred. Other desired results with different metals and physical dimensions having this range of deflection occur for forces between 0.15 and 6 lbs. are possible.

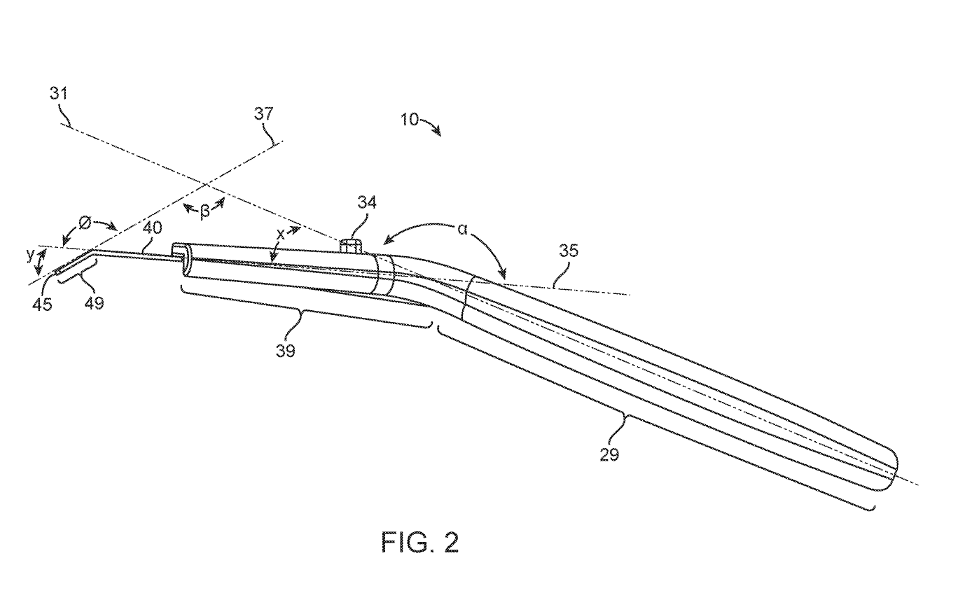

While FIGS. 18-25 show an exemplary comb blade 40 flat, i.e., without a bend such as shown in FIG. 2, one skilled in the art will readily recognize that the exemplary comb blade 40 shown in FIGS. 18-25 may be bent as described and illustrated herein. In use, the rounded-ended tines 44 can substantially engage the animal's skin thereby having the pointed ended tines 48 avoid or otherwise have reduced contact with the animal thereby reducing undesirable and uncomfortable contact for the animal while still removing loose, dead hair, and/or fur.

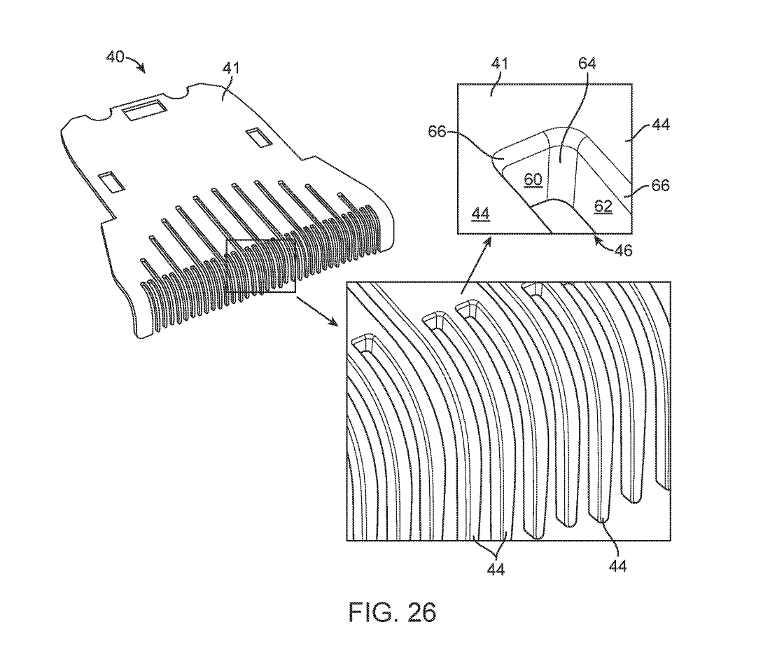

FIG. 26 shows a series of enlarged views of a comb blade illustrating a spacing 46 between exemplary tines 44. As FIG. 26 shows, the spacing 46 may be defined by a substantially planar surface 60 having sidewalls 62 (opposing sidewall not shown). In one embodiment intersecting corners 64 of the planar surface 60 and the sidewalls 62 may be rounded or otherwise smoothed so as not to form a sharp edge. Similarly, the planar surface 60 may round into a top surface 41 of the comb blade 40 along a perimeter 66 so as not to form a sharp edge.

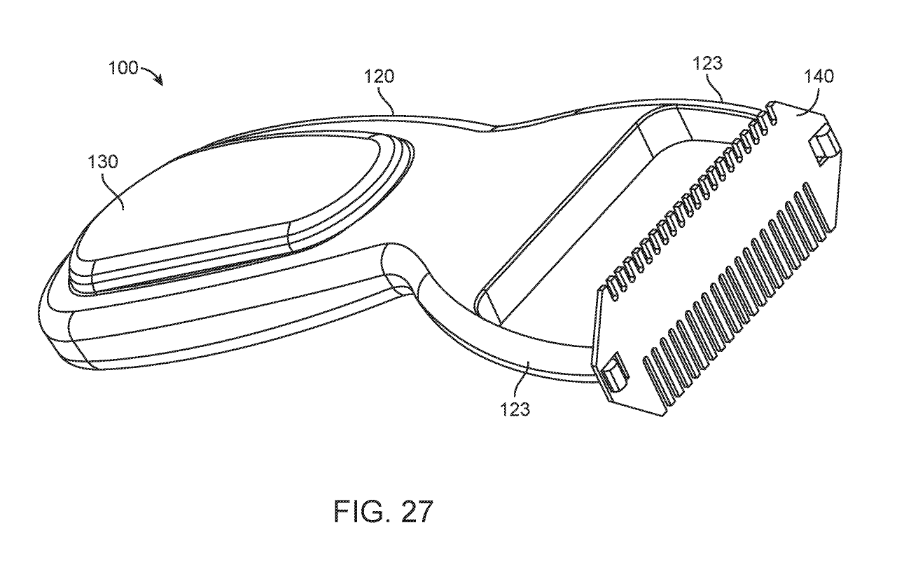

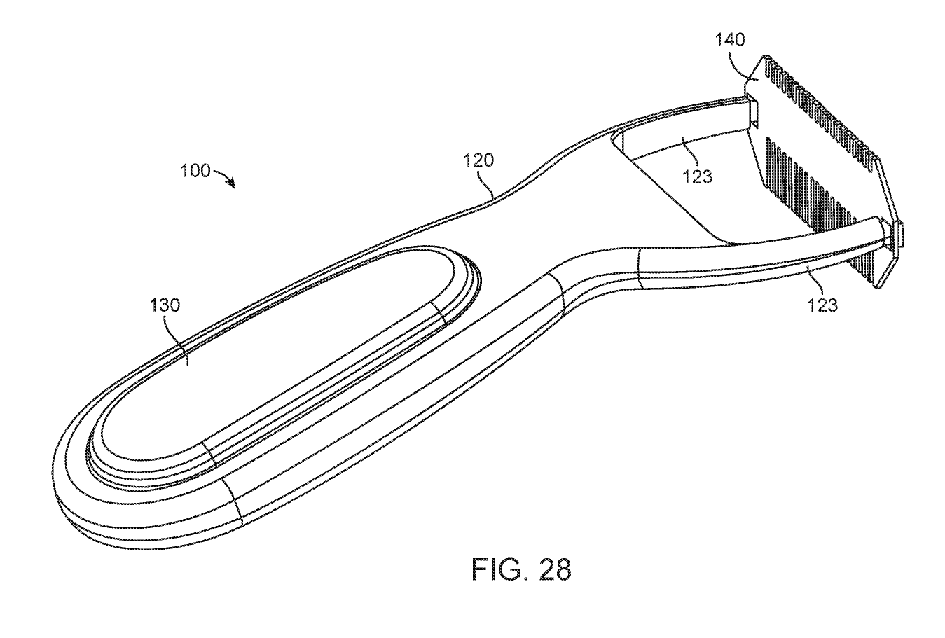

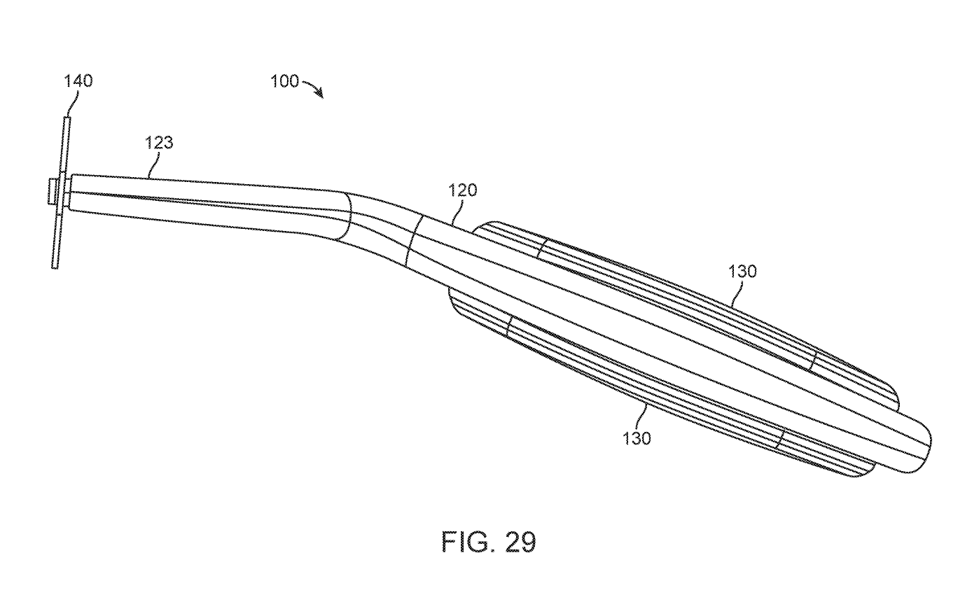

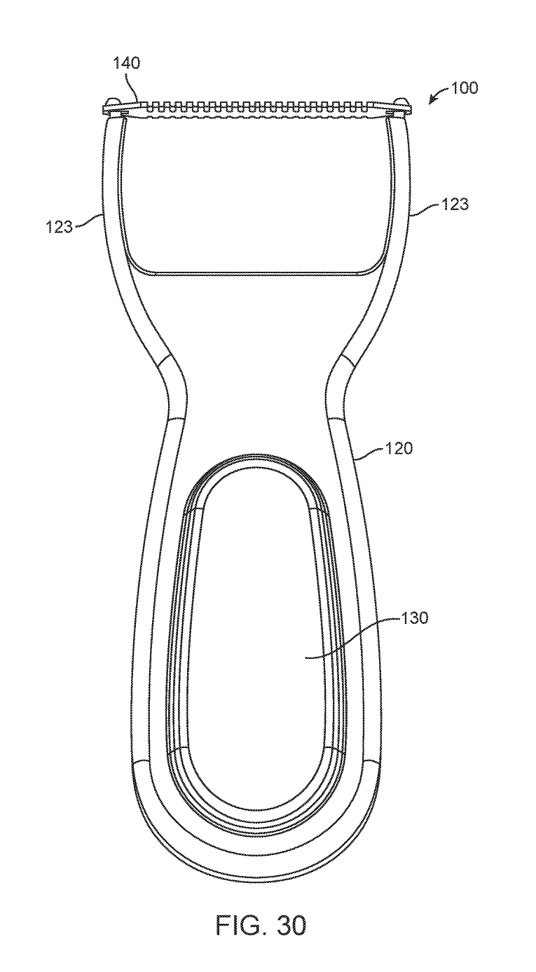

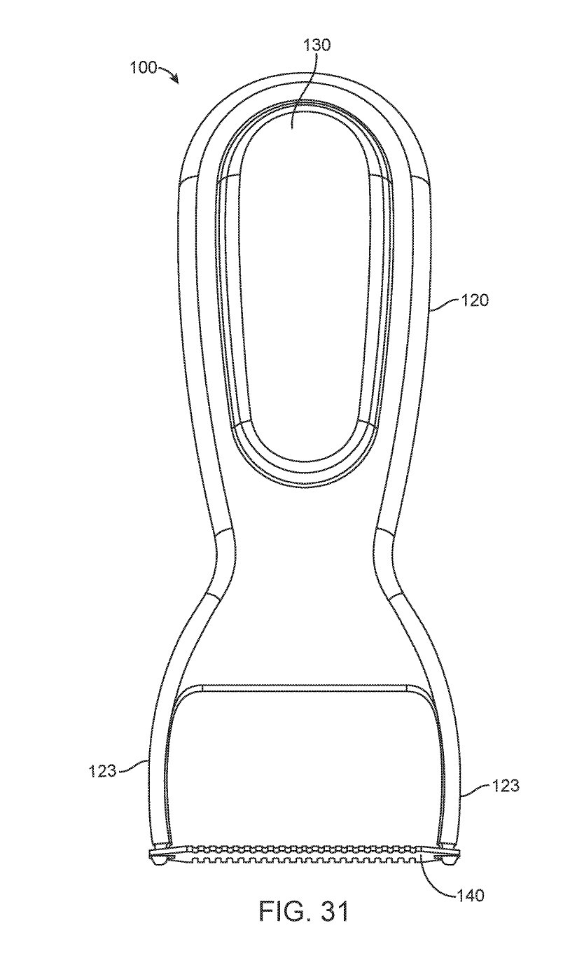

FIGS. 27-31 show another exemplary pet comb 100 that may be used to incorporate teachings found herein. As FIGS. 27-31 show, the pet comb 100 includes a handle 120, a handle insert 130, and a comb blade 140. The comb blade 140 is selectively coupled to the handle 120 as described herein below. The handle 120 includes an interface for the comb blade 140 formed of a first and second arms 123 configured to engage the comb blade 140 through an aperture thereof. The arms 123 are preferably integral to the handle 120 may be attached or otherwise adhered to a surface thereof, e.g., by snap fit or by a latch mechanism.

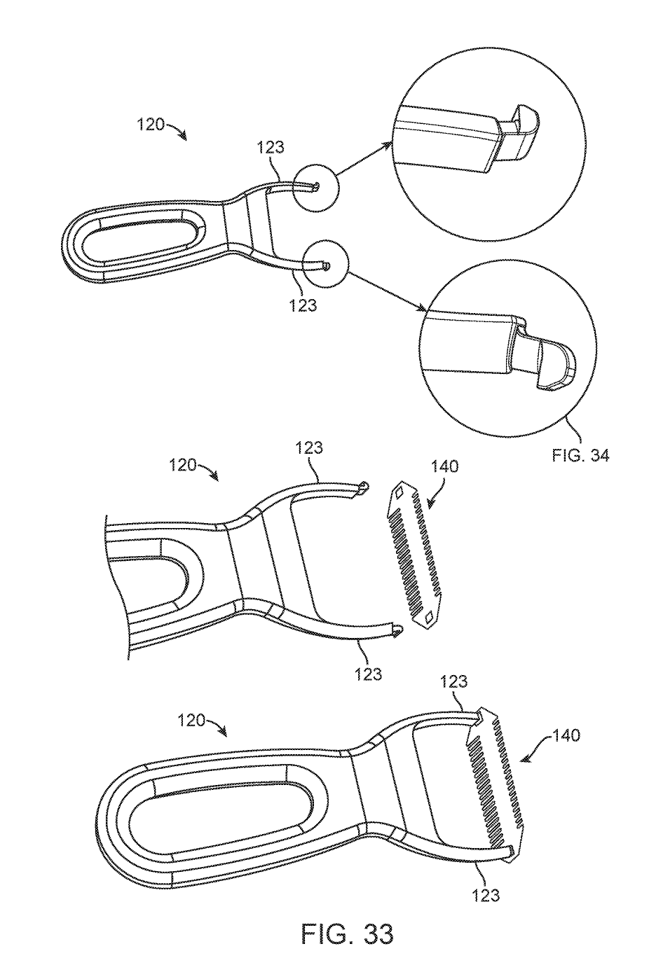

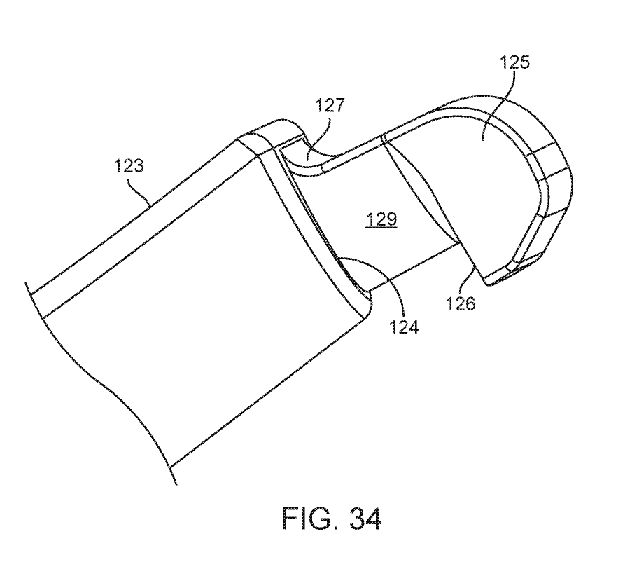

As illustrated in exemplary FIG. 33, in use, a user may press or pinch the arms 123 inward before moving the arms 123 through the comb blade aperture 142. A hook 125, on either arm 123 extends in opposite directions, securing the comb blade 140 against the arms 123. In one embodiment, the hook 125 includes flanges 126 having a planar surface for coupling to a surface of the comb blade 140. In one embodiment, a gusset 127 may buttress between the arm 123 and the flange 126 to provide support. In one embodiment, a cavity 129 may be formed between the arm 123 and the flange 126 that may form an open sided slot for securing the comb blade 140, the open sided slot being defined by a surface 129, the planar surface of the engaging side of the flange 126 and an end 124 of the arm 123.

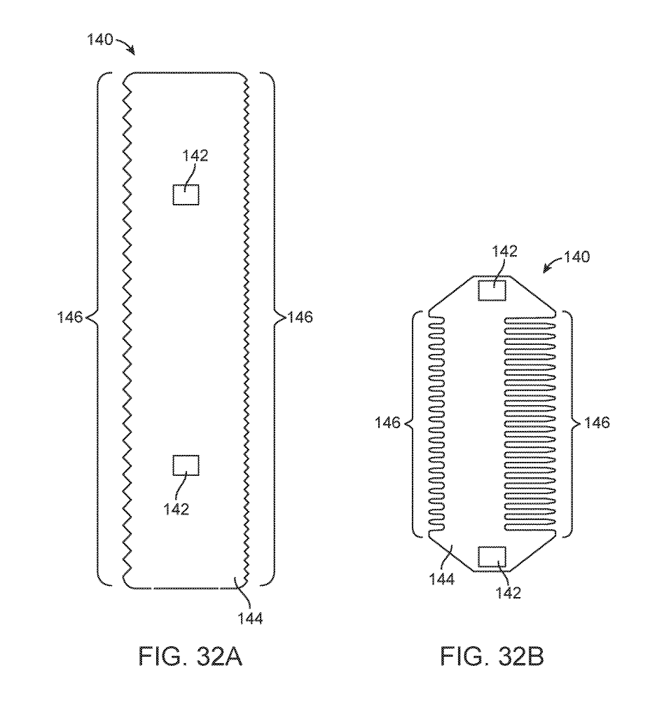

FIGS. 32A and 32B show exemplary comb blades 140 for the pet comb 100. As FIGS. 32A and 32B show, the comb blades 140 are formed of a mostly flat, planar surface 144 having a first and second apertures 142 for engaging the handle 120 via the hooks 125. The comb blades 140 may have a plurality of tines 146 on a first or second sides. The tines 146 may be arranged as described hereinabove including arrangements within a plurality of tines include a blunt-edge-end and a plurality of tines include a non-blunt-end. In one embodiment, the plurality of tines on a first side of the comb blade 140 are arranged differently than the other side. In this way, a user may simply flip the pet comb 100 180-degrees to groom an animal with a different tine adaptation. For example, wide spaced tines may be used initially on an animal, while more narrow spaced tines may be used subsequently.

In use, the pet comb 10 advantageously removes loose hair or fur from an animal. As described hereinabove, the pet comb 10 includes a handle 20 and a selectably removable comb blade 40. The handle 20 is shaped to receive the removable comb blade 40 and to hold the comb 10 in place during use. No external parts are required to make the handle 20 and comb work together, i.e., no tools or connectors are required when connecting to each other.

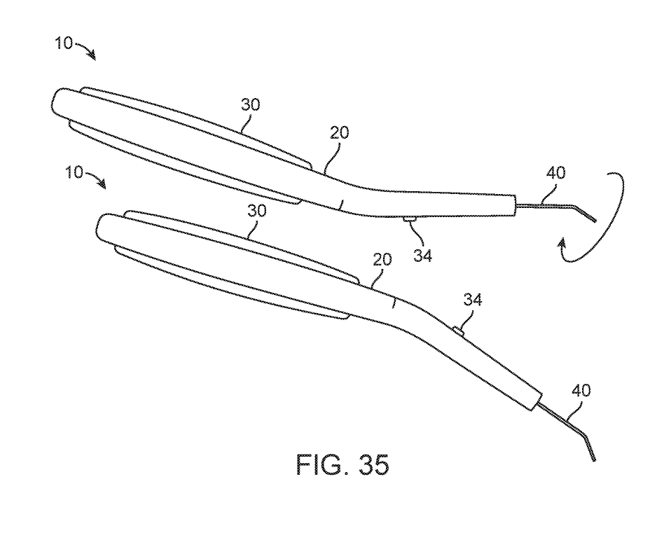

FIG. 35 shows the pet comb 10 in two exemplary positions. In various embodiments, the lower portion of the handle 20 is symmetrical or substantially symmetrical, enabling a user to flip the comb 10 180-degrees for a desired brushing angle. Different usage angles may be desired by a user for comfort purposes or a particular situation, particular hair type, and/or particular technique the comb 10 is used, e.g., light usage, or heavy usage.

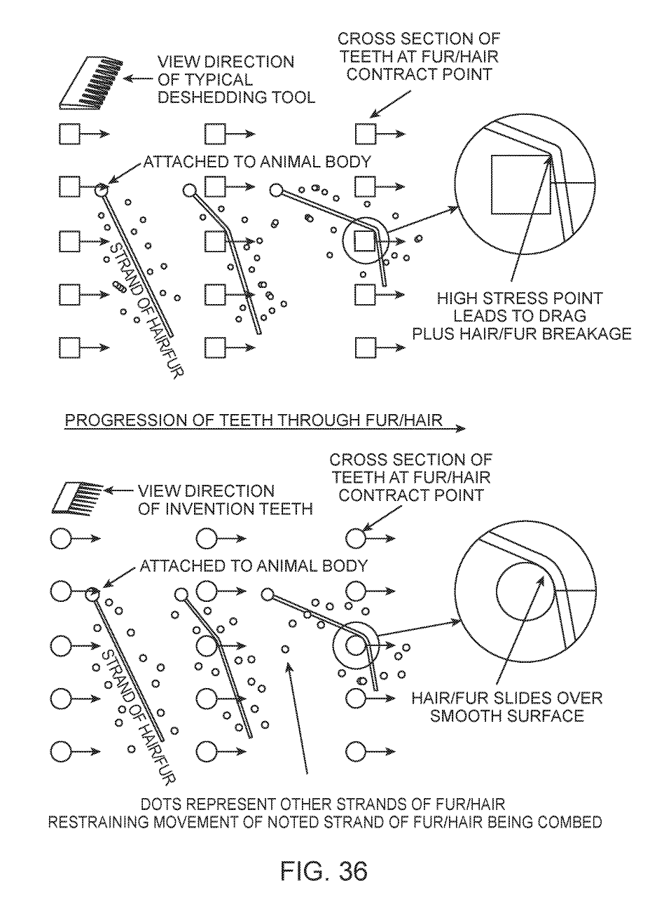

FIG. 36 illustrates operation of the tines of the comb blades 40, contrasting blunt-ended tines having a rounded cross-sectional tip with non-blunt-ended tines having an exemplary square cross-sectional tip as they are moved through animal hair. Only a single strand of hair is shown for ease of illustration and it should be recognized that the single exemplary strand of hair is restrained in a relative position to the animal's body. As FIG. 36 shows, sharp corners of the non-blunt-ended tines may create a high stress contact point with animal hair that can both cut and sharply bend the hair. Blunt-ended tines provide a smooth surface for the hair to slide over while still providing enough frictional force to gently remove dead or free strands of hair. In various embodiments, a radius of the blunt-ended and non-blunt-ended tines can be tuned or adjusted to control how aggressively the comb blade removes hair that is dead, loose, or damaged. With a radius of rounded edge near or equal to zero, healthy hair is removed along with dead, loose, or damaged hair as is the case with comb blade having sharp edges.

According to one embodiment of the invention, the pet comb 10 may be formed by assembling an etched comb portion 40 and a laser-cut handle 20. During the etching and laser-cutting configurations, the comb portion 40 and the handle 20 may be coupled together with screws and nuts, or any other coupling device. Different models may be quickly and inexpensively made; which are robust enough for field testing. The pet comb 10 may also be configured to be stamped. Stamping may not allow for intricate designs compared to etching, but once perfected through field testing, many etched combed portion designs and configurations may be tooled for stamping.

According to another embodiment of the invention, the pet comb 10 may be formed by an injection mold. The injection mold version of the pet comb 10 may be accomplished by pushing the tine piece into a slit in the handle 20, thereby forcing the slit to open up as the comb portion 40 penetrates the slit. The slit may include, in its interior, one or more protrusions (e.g. stay pins) shaped, sized and positioned to engage with one or more receiving holes of the tine piece. The slit then snaps closed once the receiving holes of the comb portion align with a plurality of protrusions molded into the handle 20.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, while specific non-overlapping bracing structures are illustrated, many other configurations of non-overlapping bracing structures are possible, including various combinations of tabs, bars, and other structures that may be protruding from and/or coupled to various portions of the handle 20 and/or its arms 23.

Also, while an array of tines 44 having a particular set of proportional lengths, shapes and positions has been described, it is understood that the variety of possible proportional lengths, shapes and positions of tines within an array of tines are plethoric.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

1. A pet comb comprising:
a handle with an interface for a comb blade; and
wherein the comb blade coupled to the handle, the comb blade having a plurality of blunt-ended tines and a plurality of non-blunt-ended tines.

2. The pet comb of claim 1, wherein the blunt-ended tines are at a forward-most position on the comb blade.

3. The pet comb of claim 1, wherein an end of at least one of the non-blunt-ended tines comprises a sharp edge.

4. The pet comb of claim 4, wherein an end of at least one of the non-blunt-ended tines comprises any one of a pointed end, a spear-like end, a blade, a wedge end, and a tapered end.

5. The pet comb of claim 1, wherein the plurality of the blunt-ended tines comprise a rounded cross-section at a tip.

6. The pet comb of claim 1, wherein the non-blunt-ended tines and the blunt-ended tines have an alternating arrangement on the comb blade with a space separating each alternating tine, and wherein said space terminates with a flat surface that is essentially perpendicular to the plane of said comb blade.

7. The pet comb of claim 1, wherein the non-blunt-ended tines and the blunt-ended tines are grouped to form a partially segmented resilient portion, wherein each group includes at least one blunt-ended tine.

8. The pet comb of claim 7, wherein the partially segmented resilient portion comprises a resiliency less than the non-blunt-ended tines and the blunt-ended tines formed thereof.

9. The pet comb of claim 1, wherein at least one of the plurality of blunt-ended tines and the plurality of non-blunt ended tines is bent at an angle relative to a plane of said comb blade.

10. The pet comb of claim 1, wherein the plurality of blunt-ended and non-blunt-ended tines are arranged in a semi-circle wherein outer tines of the plurality of blunt-ended and non-blunt-ended tines are shorter than inner tines of the plurality of blunt-ended and non-blunt-ended tines.

11. The pet comb of claim 1, wherein the wherein lengths of said tines vary across the width of said blade.

12. The pet comb of claim 1, wherein the handle comprises:
a resilient catch member having a latch protrusion configured to selectively engage the comb blade through an aperture thereof;
a first bracing portion configured to abut a first surface of the comb blade when inserted into the handle; and
a second bracing portion configured to abut a second surface of the comb blade when inserted into the handle.

13. The pet comb of claim 12, wherein the first bracing portion comprises an upper elongated bar.

14. The pet comb of claim 12, wherein the second bracing portion comprises a first and second protruding members having tapered ends for friction-fitting the comb blade when inserted into the handle.

15. A pet comb comprising:
a handle having a resilient catch member comprising a latch protrusion configured to selectively engage the comb blade through an aperture thereof;
a comb blade removably coupled to the resilient catch member, the comb blade having a plurality of blunt-ended tines and a plurality of sharp-edge-ended tines, wherein the blunt-ended tines are at a forward-most position on the comb blade, and wherein the plurality of the blunt-ended tines comprise a rounded cross-section at a tip.

16. The pet comb of claim 15, wherein the tines are separated by rounded concave spacings therebetween.

17. The pet comb of claim 15, wherein the tines are separated by a flat-planar surface spacing therebetween.

18. The pet comb of claim 17, wherein an end of at least one of the sharp-edge-ended tines comprises any one of a pointed end, a spear-like end, a blade, a wedge end, and a tapered end.

19. The pet comb of claim 15, wherein an end of at least one of the blunt-ended tines comprises any one of a ball-shaped end, a sphere-shaped end, a disc-shaped end, a dulled-surface end.

20. The pet comb of claim 15, wherein the sharp-edge-ended tines and the blunt-ended tines have an alternating arrangement on the comb blade.

21. The pet comb of claim 15, wherein the sharp-edge-ended tines and the blunt-ended tines are grouped to form a partially segmented resilient portion, wherein each group includes at least one blunt-ended tine.

22. The pet comb of claim 21, wherein the partially segmented resilient portion comprises a resiliency less than the sharp-edge-ended tines and the blunt-ended tines formed thereof.

23. The pet comb of claim 15, wherein the handle further comprises:
a first bracing portion configured to abut a first surface of the comb blade when inserted into the handle; and
a second bracing portion configured to abut a second surface of the comb blade when inserted into the handle.

24. The pet comb of claim 23, wherein the first bracing portion comprises an upper elongated bar.

25. The pet comb of claim 24, wherein the second bracing portion comprises a first and second protruding members having tapered ends for friction-fitting the comb blade when inserted into the handle.

26. The pet comb of claim 15, wherein the handle further comprises an aperture configured to friction fit a handle insert, the aperture defined by a convex interior surface.

27. The pet comb of claim 15, wherein the plurality of the blunt-ended and the sharp-edge ended tines are arranged in a manner wherein outer tines of the plurality of tines are shorter than inner tines of the plurality of tines.

28. The pet comb of claim 15, wherein the plurality of tines comprise two or more lengths.

29. A pet comb comprising:
a handle with an interface for a comb blade, the interface comprising a resilient catch member comprising a latch protrusion configured to selectively engage the comb blade through an aperture thereof;
one or more handle inserts shaped to fit within an aperture of the handle; and
wherein the comb blade is removably coupled to the resilient catch member, the comb blade having a plurality of round-ended tines and a plurality of sharp-edge-ended tines, wherein the round-ended tines are at a forward-most position on the comb blade and the sharp-edge-ended tines are set back from the forward-most position, wherein the round-ended tines and the sharp-edge tines are grouped to form a partially segmented resilient portion, wherein each group includes at least one blunt-ended tine and wherein the partially segmented resilient portion comprises a resiliency less than any one of the round-ended tines and the blunt-ended tines formed thereof, wherein at least one of the round-ended tines and the blunt-ended tines are bent at a first angle.

30. The pet comb of claim 29, wherein the latch protrusion is at a forward-most region of the resilient catch member.

31. The pet comb of claim 30, wherein the latch protrusion comprises an inclined plane-shaped end.

32. The pet comb of claim 29, wherein the handle is bent at a second angle and wherein a combined angle of the first and second angles is between 45-degrees and 125-degrees.

33. The pet comb of claim 29, wherein the handle comprises a holding portion and a comb blade receiving portion, the holding portion and the comb blade receiving portion meeting at a defined vertex, and wherein the holding portion comprises a longitudinal axis extending from the vertex to a distal end, wherein the comb blade receiving portion is angled at a generally acute angle relative to the longitudinal axis; and
wherein a combined angle of the first angle and the acute angle is between 45-degrees and 125-degrees.

34. The pet comb of claim 29, wherein the material of said blade has a hardness in a range between 40 and 60 Rockwell C.

35. The pet comb of claim 29, wherein the material of said blade has a flex modulus in the range between 20 and 60 lbf/sq-in.

36. The pet comb of claim 29, wherein the material of said blade has a yield strength in a range between 135 and 235 lbf/sq-in.

37. The pet comb of claim 1, wherein the interface between the blade and the handle is secured by friction at said interface.

38. The pet comb of claim 1, wherein the interface between the blade and the handle is secured by a snap fit.

39. The pet comb of claim 1, wherein the interface between the blade and the handle is secured by a latch.

40. The pet comb of claim 1, wherein the interface between the blade and the handle is secured by insert molding.
